(19) United States
(12) Patent Application Publication
(10) Pub. No.: US 2025/0233714 A1
(43) Pub. Date: Jul. 17, 2025

(54) DYNAMIC PRB BLANKING NEAR BORDER AREAS

(71) Applicant: T-Mobile USA, Inc., Bellevue, WA (US)

(72) Inventors: Sharath Somashekar, OVERLAND PARK, KS (US); Oscar R. Cummings, Lynwood, WA (US)

(21) Appl. No.: 18/412,287

(22) Filed: Jan. 12, 2024

(51) Int. Cl. H04L 5/00; H04W 16/14; H04W 24/10

(52) U.S. Cl. CPC H04L 5/0073; H04W 16/14; H04W 24/10

(57) ABSTRACT

Described herein are component(s) and device(s) of a telecommunications network. One or more of the components is configured to detect impact at a cell site on designated spectrum by a neighboring country user equipment (UE) associated with a different telecommunications network. A base station of the component(s) and device(s) blanks physical resource blocks (PRBs) associated with the designated spectrum in response to the detecting.

### BACKGROUND

Along borders between countries, different telecommunications network operators may have licenses to use same or overlapping radio frequency (RF) spectrum; one country may license the spectrum to one operator; the other country may license the spectrum to another operator. The telecommunications networks of those operators may thus have conflicting uses of the spectrum. A user equipment (UE) of one country may communicate with a base station at a cell site near that country's border, and that communication may negatively impact (cause “noise” on) the spectrum being used at a cell site on the other side of the border. To resolve the issue, base stations can be manually configured to statically perform physical resource block (PRB) blanking, essentially designating part of the assigned spectrum for not transmitting data in those resources and reducing the spectrum interference. While doing so may avoid conflicts with a neighboring country operator, it deprives users of the full, licensed spectrum.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram of a telecommunications network having a cell site located near a neighboring country, the cell site having component(s) and device(s) configured to detect impact of a neighboring country UE on designated spectrum and, in response, blank PRBs associated with the designated spectrum.

FIG. 2 is a flow diagram of an illustrative process for detecting impact of a neighboring country UE on designated spectrum of a telecommunications network and, in response, blanking PRBs associated with the designated spectrum.

FIG. 3 is a schematic diagram of a computing device capable of implementing functionality of at least one of the component(s) or device(s) of the telecommunications network.

### DETAILED DESCRIPTION

This disclosure is directed in part to component(s) and device(s) of a telecommunications network capable of dynamic PRB blanking. One or more of the components is configured to detect, at a cell site of the telecommunications network, impact on designated spectrum by a neighboring country UE associated with a different telecommunications network. A base station of the component(s) and device(s) blanks PRBs associated with the designated spectrum in response to the detecting.

As used herein, “component(s) and device(s) of the telecommunications network” may include any of cell site equipment, such as a probe, base station, analyzer, spectrum access system (SAS), scheduler, radio hardware, operation support server (OSS), or any combination of any two or more of these.

A “neighboring country UE” can include any device across a border having an impact on designated spectrum (e.g., an increase in noise level) by transmitting or receiving over RF spectrum (e.g., spectrum that is the same as, overlaps with, or is adjacent to the designated spectrum). Also, while a “neighboring country” is referred to throughout the specification, it is to be understood that a neighboring country may be any entity having its own ability to license spectrum differently.

Also, as used herein, “blanking, by the base station at the cell site, physical resource blocks (PRBs) associated with the designated spectrum” can include blanking only a part of the designated spectrum, blanking all of the designated spectrum, or blanking spectrum adjacent to the designated spectrum along with all or a part of the designed spectrum.

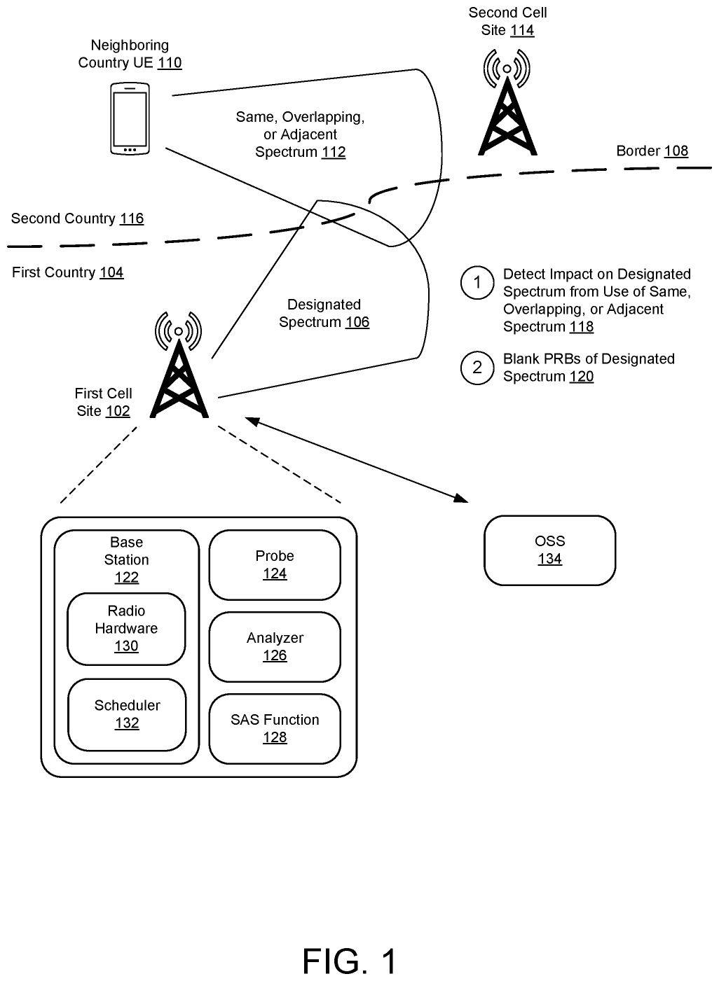

FIG. 1 is an overview diagram of a telecommunications network having a cell site located near a neighboring country, the cell site having component(s) and device(s) configured to detect impact of a neighboring country UE on designated spectrum and, in response, blank PRBs associated with the designated spectrum. As illustrated, a first cell site 102 in a first country 104 is capable of transmitting and receiving over RF spectrum, including the designated spectrum 106. Across a nearby border 108, a neighboring country UE 110 transmits or receives over a same, overlapping, or adjacent spectrum 112 (“same, overlapping, or adjacent” as the designated spectrum 106) of a second cell site 114 in a second country 116. At 118, the use of the same, overlapping, or adjacent spectrum 112 may impact the designated spectrum 106 (e.g., cause a rise in a detected noise level) and, in response at 120, a base station 122 of the first cell site 102 may blank PRBs of the designated spectrum 106. As further shown in FIG. 1, in addition to the base station 122, the first cell site can include a probe 124, analyzer 126, and a SAS function 128. The base station 122 can include radio hardware 130 and a scheduler 132. Further, the component(s) and device(s) of the first cell site 102 may communicate with an OSS 134, which may provide configuration, a baseline for detecting impact, machine learning, etc. used by the component(s) and device(s).

In various implementations, the first country 104 and second country 116 may be any two jurisdictions that are each capable of licensing RF spectrum and share a common border 108. The first country 104 and second country 116 may each be a nation state, a confederation or union of nation states, or a subnational union capable of controlling wireless communication within its boundaries.

Because each of the first country 104 and second country 116 can control a same frequency band or group of frequency bands within its territory, spectrum on either side of the border 108 may licensed to a different telecommunications network and different telecommunications network operator (also referred to herein simply as “operator”). An operator with a telecommunications network having a cell site 102 in the first country 104 may be licensed to use the designated spectrum 106 in the first country 104, and another operator with a telecommunications network having a cell site 114 in the second country 116 may be licensed to use the same, overlapping, or adjacent spectrum 112. Such spectrum use can involve frequency division duplexing (FDD) by both telecommunication network, time division duplexing (TDD) by both telecommunication networks, or FDD by one and TDD by the other. In any case, the use of spectrum on one telecommunications network can impact the other spectrum by, e.g., causing an increase in a noise level detected on that other spectrum. Spectrum 106 and 112 may each belong to any frequency band, such as low band, mmWave band, etc.

In further implementations, the second cell site 114 may include a base station, radio tower, power source, etc. and may be a macrocell, microcell, picocell, femtocell, etc. The second cell site 114 coverage may be of any technologically feasible size and the equipment at the second cell site 114 may include any type of equipment found at cell sites, with a base station having any capabilities for wireless communication and other access point operation. The base station at the second cell site 114 may include an antenna or antenna array for sending and receiving communications over at least the same, overlapping, or adjacent spectrum 112.

The UE 110 may move into range of the second cell site 114 and begin transmitting over the same, overlapping, or adjacent spectrum 112. After some period of time communicating over the same, overlapping, or adjacent spectrum 112, the UE 110 may cease communicating over the same, overlapping, or adjacent spectrum 112 or move out of range. Such a UE 110 may be any sort of UE, such as a mobile phone, connected vehicle, watch, Internet-of-Things (IoT) device, etc.

As illustrated in FIG. 1, on the other side of the border 108 in the first country 104, the first cell site 102 may include a base station 122, a probe 124, an analyzer 126, and a SAS function 128. The base station 122 can include radio hardware 130 and a scheduler 132. The first cell site 102 may also include additional components or fewer than these components 122-132 (e.g., with one component or device performing the functions of others of components 122-132).

In some implementations, the first cell site 102 includes a probe 124. The probe 124 may be hardware placed atop a radio tower of the first cell site 102 and may sample an RF signal waveform for the designated spectrum 106. The sampled signal waveform can be analyzed by the analyzer 126 that may be a component of the probe 124 or a separate component. The probe 124 may be configured with the designated spectrum 106 and any other spectrum to sample by the OSS 134. The OSS 134 may also provide the analyzer 126 or probe 124 with a baseline level of noise to measure obtained samples against. Upon detecting that the samples have exceeded the baseline or returned below it, the probe 124/analyzer 126 may report to the base station 122 and/or the OSS 134 either the exceeding or returning as well as start and stop frequencies associated with the detected noise/impact.

The SAS function 128 may be a hardware component of the first cell site 102 or a software component of a different hardware component of the first cell site 102 or the OSS 134. The SAS function 128 may exchange information elements with another operator (such as the operator of the telecommunications network including second cell site 114) in, e.g., another country and may operate agnostic of frequencies. Each operator communicating via the SAS function 128 may identify devices for given cell sites (e.g., first cell site 102 and second cell site 114) and what frequencies those devices are communicating on. This information, when received by the SAS function 128, may be provided to the analyzer 126, base station 122, or OSS 134 for use in determining that a UE 110 is impacting designated spectrum 106. This information may be used along with the samples obtained by the probe 124 or alternatively to those samples.

In various implementations, the radio hardware 130 of the base station 122 can, sample radio waveforms in accordance with logic of a software version of probe 124. Thus, the radio hardware 130 and software version of the probe 124 can together perform the same operations as the probe 124 (and, in some implementations, as the analyzer 126 as well). Such a software version of the probe 124 can be implemented in the base station 122 or in other equipment of the first cell site 102.

The base station 122 may itself be of any radio access technology, such as Long-Term Evolution (LTE) or New Radio (NR). The base station 122 may then be an eNodeB (eNB) or a gNodeB (gNB). Alternatively, the base station 122 may be of any earlier or later radio access technology. The scheduler 132 of the base station 122 may be configured to allocate spectrum to connecting devices, providing those devices with wireless connectivity. The scheduler 132 may also be involved in PRB blanking by setting the PRBs to be blanked aside and not scheduling any connections to those PRBs. Along with this, the scheduler 132 may move UEs of the telecommunications network to other usable regions of spectrum to avoid any impact from the UEs, for instance on spectrum used by the UE 110 on the other telecommunications network.

In some implementations, the base station 122 can receive a designation of a start frequency and stop frequency from the probe 124/analyzer 126, from the OSS 134, or from the SAS function 128. These start and stop frequencies can then be compared against a database of known network operators and their spectrum allocations to identify a bandwidth surrounding the start and stop frequencies. It is the PRBs of this identified bandwidth that the base station 122 determines to blank. In some implementations, the identified bandwidth is used with a machine learning component to determine how much spectrum to blank—this may be more or less that the identified bandwidth. The machine learning component may use prior baseline modelled data. The database of known network operators and machine learning component may each be implemented on the base station 122, the OSS 134, or across both.

As further noted herein, the base station 122 may also receive an indication from the probe 124/analyzer 126, SAS function 128, or OSS 134 that the UE 110 is not longer impacting the designated spectrum 106. Upon receiving this, the scheduler 132 may cease contributing to PRB blanking and may utilize the full spectrum for UEs of the telecommunications network, including the designated spectrum 106.

In various implementations, the OSS 134 may store a baseline for the probe 124/analyzer 126 and a configuration specifying the designated spectrum 106. The OSS 134 may provide these to the first cell site 102 periodically or on an event-driven basis (e.g., upon request, reboot, initial connection, etc.). The OSS 134 may also include either or both of the database of known network operators or the machine learning component and can receive indications of start and stop frequencies from the probe 124/analyzer 126 and determine the spectrum to be blanked based on those start and stop frequencies. Also or instead, it may receive identifications of the spectrum being used from the SAS function 128 and utilize those identifications to determine the spectrum to be blanked. It may also provide instructions to the base station 122 to blank PRBs, identifying the spectrum to be blanked.

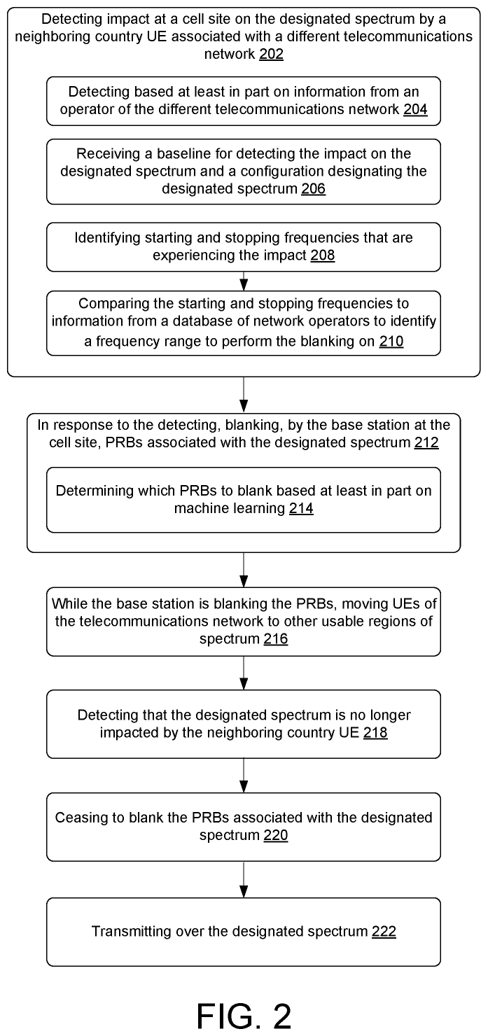

FIG. 2 illustrates an example process. This process is illustrated as logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process for detecting impact of a neighboring country UE on designated spectrum of a telecommunications network and, in response, blanking PRBs associated with the designated spectrum. As illustrated at 202, one or more components of the telecommunications network detect impact at a cell site on the designated spectrum by a neighboring country user equipment (UE) associated with a different telecommunications network. In some implementations, the one or more components may include at least one of (1) a probe collocated at the cell site with a base station of the telecommunications network or (2) radio hardware of the base station. At 204, the detecting may be based at least in part on information from an operator of the different telecommunications network. At 206, the detecting may include receiving a baseline for detecting the impact on the designated spectrum and a configuration designating the designated spectrum. Also or instead, the detecting may include, at 208, identifying starting and stopping frequencies that are experiencing the impact and, at 210, comparing the starting and stopping frequencies to information from a database of network operators to identify a frequency range to perform the blanking on.

At 212, in response to the detecting, the base station at the cell site blanks PRBs associated with the designated spectrum. At 214, the blanking may include determining which PRBs to blank based at least in part on machine learning.

At 216, while the base station is blanking the PRBs, a scheduler of the base station may move UEs of the telecommunications network to other usable regions of spectrum.

At 218, the one or more components may then detect that the designated spectrum is no longer impacted by the neighboring country UE. In response, the base station may, at 220, cease to blank the PRBs associated with the designated spectrum and, at 222, transmit over the designated spectrum.

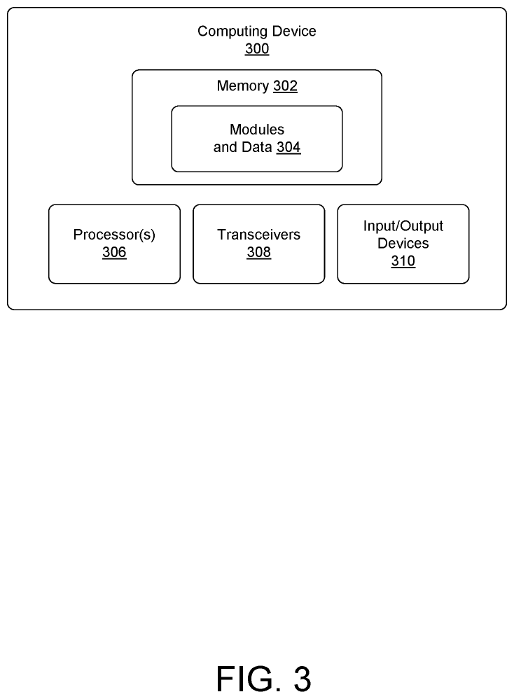

FIG. 3 is a schematic diagram of a computing device capable of implementing functionality of at least one of the component(s) or device(s) of the telecommunications network. As shown, the computing device 300 includes a memory 302 storing modules and data 304, processor(s) 306, transceivers 308, and input/output devices 310.

In various examples, the memory 302 can include system memory, which may be volatile (such as RAM), non-volatile (such as ROM, flash memory, etc.) or some combination of the two. The memory 302 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 302 can include one or more software or firmware elements, such as computer-readable instructions that are executable by the one or more processors 306. For example, the memory 302 can store computer-executable instructions associated with modules and data 304. The modules and data 304 can include a platform, operating system, and applications, and data utilized by the platform, operating system, and applications. Further, the modules and data 304 can implement any of the functionality for the base station 122, the probe 124, the analyzer 126, the SAS function 128, or the OSS 134, or any other node/device described and illustrated herein.

In various examples, the processor(s) 306 can be a central processing unit (CPU), a graphics processing unit (GPU), or both CPU and GPU, or any other type of processing unit. Each of the one or more processor(s) 306 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 306 may also be responsible for executing all computer applications stored in the memory 302, which can be associated with types of volatile (RAM) and/or nonvolatile (ROM) memory.

The transceivers 308 can include modems, interfaces, antennas, Ethernet ports, cable interface components, and/or other components that perform or assist in exchanging wireless communications, wired communications, or both.

While the computing device need not include input/output devices 310, in some implementations it may include one, some, or all of these. For example, the input/output devices 310 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 310 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 310 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method implemented by a telecommunications network, comprising:
detecting, by one or more components of the telecommunications network, impact at a cell site on designated spectrum by a neighboring country user equipment (UE) associated with a different telecommunications network; and
in response to the detecting, blanking, by a base station at the cell site, physical resource blocks (PRBs) associated with the designated spectrum.

2. The method of claim 1, further comprising:
detecting that the designated spectrum is no longer impacted by the neighboring country UE;
ceasing to blank the PRBs associated with the designated spectrum; and
transmitting over the designated spectrum.

3. The method of claim 1, wherein the one or more components include at least one of a probe collocated at the cell site with the base station or radio hardware of the base station.

4. The method of claim 1, wherein the detecting is based at least in part on information from an operator of the different telecommunications network.

5. The method of claim 1, wherein the detecting includes receiving a baseline for detecting the impact on the designated spectrum and a configuration designating the designated spectrum.

6. The method of claim 1, wherein the detecting includes:
identifying starting and stopping frequencies that are experiencing the impact; and
comparing the starting and stopping frequencies to information from a database of network operators to identify a frequency range to perform the blanking on.

7. The method of claim 1, wherein the blanking includes determining which PRBs to blank based at least in part on machine learning.

8. The method of claim 1, further comprising, while blanking the PRBs, moving, by a scheduler of the base station, UEs of the telecommunications network to other usable regions of spectrum.

9. A cell site of a telecommunications network, the cell site located near a border with another country, comprising:
a probe configured to detect impact on designated spectrum by a neighboring country user equipment (UE) associated with a different telecommunications network; and
a base station configured to blank physical resource blocks (PRBs) associated with the designated spectrum.

10. The cell site of claim 9, wherein the probe is further configured to detect that the designated spectrum is no longer impacted by the neighboring country UE, and
wherein a base station is further configured to cease blanking the PRBs associated with the designated spectrum and to transmit over the designated spectrum.

11. The cell site of claim 9, further comprising:
a spectrum access system (SAS) function configured to be operated by a processor of the cell site to exchange information with an operator of the different telecommunications network about spectrum being used,
wherein the probe is further configured to detect the impact on the designated spectrum based at least in part on the information received from the operator.

12. The cell site of claim 9, wherein the probe is further configured to detect the impact based at least in part on a baseline for the detecting and on a configuration designating the designated spectrum, wherein the probe is configured to receive the baseline and the configuration from an operational support server of the telecommunications network.

13. The cell site of claim 9, wherein the detecting includes:
identifying starting and stopping frequencies that are experiencing the impact; and
comparing the starting and stopping frequencies to information from a database of network operators to identify a frequency range to perform the blanking on.

14. The cell site of claim 9, wherein the blanking includes determining which PRBs to blank based at least in part on machine learning.

15. The cell site of claim 9, wherein the base station further includes a scheduler, the scheduler being configured to move UEs of the telecommunications network to other usable regions of spectrum while the base station blanks the PRBs.

16. A non-transitory computer storage medium having a plurality of programming instructions stored thereon that, when executed by one or more processors of component(s) and device(s) of a telecommunications network, perform operations comprising:
detecting, by one or more of the component(s), impact at a cell site on designated spectrum by a neighboring country user equipment (UE) associated with a different telecommunications network; and
in response to the detecting, blanking, by a base station of the component(s) and device(s), physical resource blocks (PRBs) associated with the designated spectrum.

17. The non-transitory computer storage medium of claim 16, wherein the operations further comprise:
detecting that the designated spectrum is no longer impacted by the neighboring country UE;
ceasing to blank the PRBs associated with the designated spectrum; and
transmitting over the designated spectrum.

18. The non-transitory computer storage medium of claim 16, wherein the detecting includes receiving a baseline for detecting the impact on the designated spectrum and a configuration designating the designated spectrum.

19. The non-transitory computer storage medium of claim 16, wherein the detecting includes:
identifying starting and stopping frequencies that are experiencing the impact; and
comparing the starting and stopping frequencies to information from a database of network operators to identify a frequency range to perform the blanking on.

20. The non-transitory computer storage medium of claim 16, wherein the operations further comprise, while blanking the PRBs, moving, by a scheduler of the base station, UEs of the telecommunications network to other usable regions of spectrum.
